(19) United States
(12) Patent Application Publication
(10) Pub. No.: US 2025/0110575 A1
(43) Pub. Date: Apr. 3, 2025

(54) KEYBOARD COVERS AND METHODS

(71) Applicant: SNICE PROTECTERS LLC, Las Vegas, NV (US)

(72) Inventors: Nicholas NIGRO, Las Vegas, NV (US); Jake CHRISTENSEN, Las Vegas, NV (US)

(73) Assignee: SNICE PROTECTERS LLC, Las Vegas, NV (US)

(21) Appl. No.: 18/899,452

(22) Filed: Sep. 27, 2024

Related U.S. Application Data
(60) Provisional application No. 63/586,174, filed on Sep. 28, 2023.

(51) Int. Cl. G06F 3/02

(52) U.S. Cl. CPC G06F 3/0202

(57) ABSTRACT

A cover includes a surface, and a plurality of button covers protruded from the main keyboard cover surface. The button covers include a first button cover. The first button cover includes a first protrusion and a second protrusion. The first protrusion includes a button frame surface. The second protrusion includes a primary button surface. An edge of the button frame surface non-overlaps with an edge of the primary button surface in a first direction.

### CROSS REFERENCE TO RELATED APPLICATIONS

This U.S. patent application claims the benefit of U.S. Provisional Application No. 63/586,174, filed Sep. 28, 2023, entitled KEYBOARD COVER AND METHODS which is hereby incorporated by reference in its entirety.

### TECHNICAL FIELD

The disclosure relates to an input device cover or overlay (e.g., cover or overlay for a panel of physical keys or buttons).

### BACKGROUND

Input devices, such as keyboards, keypads, and button panels, are ubiquitous interfaces for computing and gaming devices. These input devices allow users to enter information or make selections by pressing buttons or keys. Once pressed, the keyboard, keypad, or button panel sends a signal to the associated computing device to register the user's selection. However, the design of keyboards, keypads, and button panels allows dirt to accumulate during use and makes them susceptible to foreign matter and moisture.

### SUMMARY

Disclosed are keyboard covers (e.g., semi-clear thermoplastic polyurethane (TPU) keyboard cover) which are operable to prevent dirt and liquid from interacting with a keyboard integrated into a gaming device. An adhesive surface (e.g., adhesive layer) is provided to ensure that the cover remains secured to the keys. The height and width of the keyboard receiving components have a height and width corresponding to the keys and are deeper than currently available keyboard covers.

Also disclosed are button panel covers (e.g., semi-clear thermoplastic polyurethane (TPU) gaming machine button panel cover) which are operable to prevent dirt and liquid from interacting with the individual static or dynamic buttons integrated on the gaming device. An adhesive surface (e.g., adhesive layer) is provided to ensure that the cover remains secured to the dynamic and/or static buttons on the gaming machine. An antimicrobial layer (e.g., antimicrobial treatment) can also be applied. The height and width of the button panel receiving components have a height and width that is specifically designed for gaming machines button panels/deck only. Especially to keep the functionality and ease of use of the gaming machines button panel in mind, while also providing a layer of protection from and environmental influence. There is no design or product built to protect these static or dynamic gaming machine button decks.

The covers are operable to protect gaming machines such as the exemplar gaming (machine) device 100 of FIG. 1 from liquids, dirt, food, and other foreign matter. The gaming machine keyboards include, but are not limited to, gaming machine button panels, gaming machine button decks, static button panels, dynamic button panels, static button decks, or virtual button decks.

As will be appreciated by those skilled in the art, when a machine gets spilled on, especially at a bar top, the machine cannot be used. An operator must make a site visit to fix the machine which can result in a loss of gaming revenue. The keyboard covers (such as button panel covers) protect machines from damage during use, ensuring they remain functional and active. The covers also increase the longevity of the machines. The covers are vacuum formed to optimize the fit to the keys (e.g., buttons). The cover can be made from 100% latex free material (e.g., silicon, TPU) that is abrasion and/or chemical resistant. The cover may include features such as an adhesive (e.g., double coated acrylic).

One aspect of the disclosure provides a cover for covering input device. The cover includes a primary cover surface, and a plurality of button covers protruded from the primary cover surface. The button covers include a first button cover. The first button cover includes a first protrusion (e.g., first protrusion surface) and a second protrusion (e.g., second protrusion surface). The first protrusion includes a first button frame surface. The second protrusion includes a primary button surface. An edge of the button frame surface non-overlaps with an edge of the primary button surface in a first direction (e.g., vertical direction).

Implementations of the disclosure may include one or more of the following optional features. In some implementations, the first protrusion has a first width and second protrusion has a second width, and the first width is greater than the second width. In some implementations, the button frame surface is formed to cover a top surface of a first button frame, and the primary button surface is formed to cover a top surface of a first button associated with the first button frame. In some implementations, the first protrusion and the second protrusion form a first recess that corresponds in shape to a first button and a first button frame associated with the first button. In some implementations, the keyboard cover includes a semi-clear thermoplastic polyurethane. In some implementations, the keyboard cover includes a silicon. In some implementations, the first protrusion and the second protrusion form a stepped surface. In some implementations, a width of a bottom portion of the first protrusion is greater than a width of an upper portion of the first protrusion. The upper portion of the first protrusion is closer to the second protrusion than the bottom portion of the first protrusion. In some implementations, the cover further includes an adhesive layer. In some implementations, the cover further includes an antimicrobial layer.

Another aspect of the disclose provides a cover for covering input device. The cover includes a surface, and a plurality of button covers protruded from the surface. The button covers include a first button cover and a second button cover adjacent to the first button cover. Each of the first button cover and the second button cover has a first protrusion (e.g., first protrusion surface) extended from the surface and a second protrusion (e.g., second protrusion surface) extended from the first protrusion. The first protrusion of the first button cover includes a first button frame surface. The second protrusion of the first button cover includes a first primary button surface. The first protrusion of the second button cover includes a second button frame surface. The second protrusion of the second button cover includes a second primary button surface.

Implementations of the disclosure may include one or more of the following optional features. In some implementations, the first button cover and the second button cover are arranged in a first direction. In some implementations, a portion of the surface is disposed between the first button cover and the second button cover. In some implementations, the first button frame surface is formed to cover a top surface of a first button frame. The first primary button surface is formed to cover a top surface of a first button. The second button frame surface is formed to cover a top surface of a second button frame. The second primary button surface is formed to cover a top surface of a second button. In some implementations, a first height of the first button frame surface from the surface and a second height of the second button frame surface from the surface are the same. In some implementations, a first height of the first button frame surface from the surface and a second height of the second button frame surface from the surface are different. In some implementations, the first protrusion of the first button cover and the second protrusion of the first button cover form a first stepped surface, and the first protrusion of the second button cover and the second protrusion of the second button cover form a second stepped surface. In some implementations, the first protrusion of the first button cover and the second protrusion of the first button cover form a first recess that corresponds in shape to a first button and a first button frame associated with the first button, and the first protrusion of the second button cover and the second protrusion of the second button cover form a second recess that corresponds in shape to a second button and a second button frame associated with the second button. In some implementations, a width of a bottom portion of the first protrusion is greater than a width of an upper portion of the first protrusion, and the upper portion of the first protrusion is closer to the second protrusion than the bottom portion of the first protrusion.

Another aspect of the disclose provides a method of manufacturing a cover. The method includes applying heat to a sheet. The method also includes positioning the sheet on a mold. The method further includes applying vacuum between the sheet and the mold. The mold is fabricated to produce one or more covers. The one or more covers include a surface, and a plurality of button covers protruded from the surface. The button covers include a first button cover and a second button cover adjacent to the first button cover. Each of the first button cover and the second button cover has a first protrusion (e.g., first protrusion surface) extended from the surface and a second protrusion (e.g., second protrusion surface) extended from the first protrusion. The first protrusion of the first button cover includes a first button frame surface. The second protrusion of the first button cover includes a first primary button surface. The first protrusion of the second button cover includes a second button frame surface. The second protrusion of the second button cover includes a second primary button surface.

Implementations of the disclosure may include one or more of the following optional features. In some implementations, the method includes cooling the sheet. In some implementations, the method includes applying an adhesive layer. In some implementations, the method includes applying an antimicrobial layer.

The details of one or more implementations of the disclosure are set forth in the accompanying drawings and the description below. Other aspects, features, and advantages will be apparent from the description and drawings, and from the claims.

Both the foregoing description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
Alibaba, Transparent Laptop TPU Keyboard skin (2023);
Ave Stores, Clear Desktop Computer Keyboard Cover Skin (2023);
JuYuish, Ultra Thin Desktop PC Silicone Clear Keyboard Cover Skin Protector (2023);
CN107068463A published Aug. 18, 2017 by Lai et al.;
CN207264320U issued Apr. 20, 2018 by Shen Weiwei et al.;
KR200335894Y1 issued Dec. 11, 2003 by Ahn Gwang-gu;
TWM364236Y1 issued Sep. 1, 2009 by CHEN JUN-HUANG;
U.S. Pat. No. 11,416,083B2 issued Aug. 16, 2022 by Chan et al.;
US20090218207A1 published Sep. 3, 2009 by Mou;
U.S. Pat. No. 4,436,965A issued Mar. 13, 1984 by Morse;
U.S. Pat. No. 9,056,244B2 issued Jun. 16, 2015 by Lesley et al.;
U.S. Pat. No. 9,978,545B2 issued May 22, 2018 by Onoyama et al.; and
U.S. Pat. No. 9,995,478B2 issued Jun. 12, 2018 by Onoyama et al.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a device with a keyboard interface;

FIG. 2 is a perspective view of a keyboard cover;

FIGS. 3A-3F illustrate top and side views of a keyboard cover (e.g., button panel cover), along with top and side views of key covers (e.g., button covers) in various shapes associated with the keyboard cover in accordance with the disclosure;

FIGS. 4A-4G illustrate top and side views of a keyboard cover (e.g., button panel cover), along with top and side views of key covers (e.g., button covers) in various shapes, in another embodiment of the keyboard cover in accordance with disclosure;

FIGS. 5A-5F illustrate top and side views of a keyboard cover (e.g., button panel cover), along with top and side views of key covers (e.g., button covers) in various shapes, in another embodiment of the keyboard cover in accordance with disclosure;

FIGS. 6A-6F illustrate the keyboard cover applied to an exemplar keyboard interface; and

FIG. 7 is a flowchart of an example arrangement of operations for a method of manufacturing a keyboard cover (e.g., button panel cover).

### DETAILED DESCRIPTION

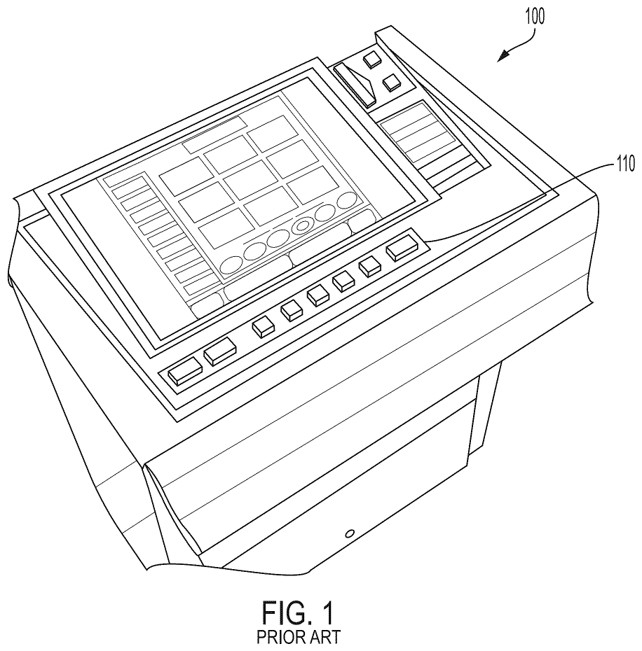

FIG. 1 illustrates a device 100 with a keyboard interface 110 (e.g., button panel). The device is a gaming device and the keyboard interface 110. In this example, the keyboard interface 110 (e.g., button panel) is integrated into the device 100. The keyboard interface 110 is used to allow a user to play the game on the screen. These exemplar gaming machines cost thousands of dollars and are an investment for these businesses. The keyboard interface or gaming machine keyboard includes, but are not limited to, gaming machine button panels, gaming machine button decks, static button panels, dynamic button panels, static button decks, or virtual button decks.

### I. Devices

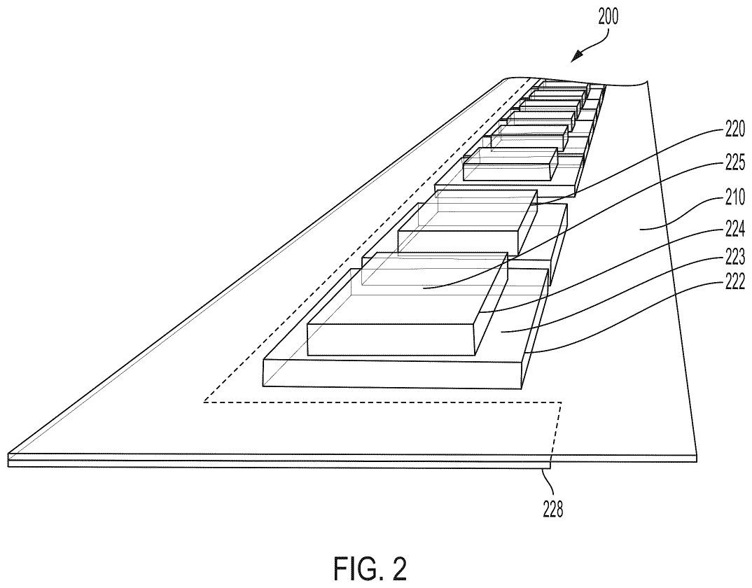

FIG. 2 is a perspective view of a keyboard cover 200 (e.g., button panel cover) in accordance with the disclosure. The keyboard cover 200 may include thermoplastic polyurethane (TPU) (e.g., semi-clear TPU). The keyboard cover 200 may include plastic material. The keyboard cover 200 may include elastomer material (e.g., silicone). For example, the keyboard cover 200 may include at least one of: silicone rubber, polyvinyl chloride (PVC), thermoplastic elastomer (TPE), polyethylene (PE), polypropylene (PP), polycarbonate (PC), polyethylene terephthalate (PET), or polyurethane (PU). The use of a TPU layer allows light from a gaming machine button and associated text on the gaming machine button to be visible during use. An adhesive layer 228 can be positioned on either fully or partially on an interior surface operable to engage the keys of the keyboard (e.g., buttons of button panel). Suitable adhesive layers include a double coated acrylic. An antimicrobial layer (e.g., antimicrobial treatment) can also be applied on the top surface. The keyboard cover 200 materials are selected to provide an abrasion resistant and chemically resistant interface between the keyboard and the user. The abrasion resistant material is operable to prevent holes being formed in the keyboard cover, and scuffing of the keyboard cover with application of friction. The chemically resistant material is operable to prevent alteration of the cover when, for example, a substance is applied to a surface-whether intentionally (e.g., cleaning product) or unintentionally (e.g., spilled). The materials can also be 100% latex free.

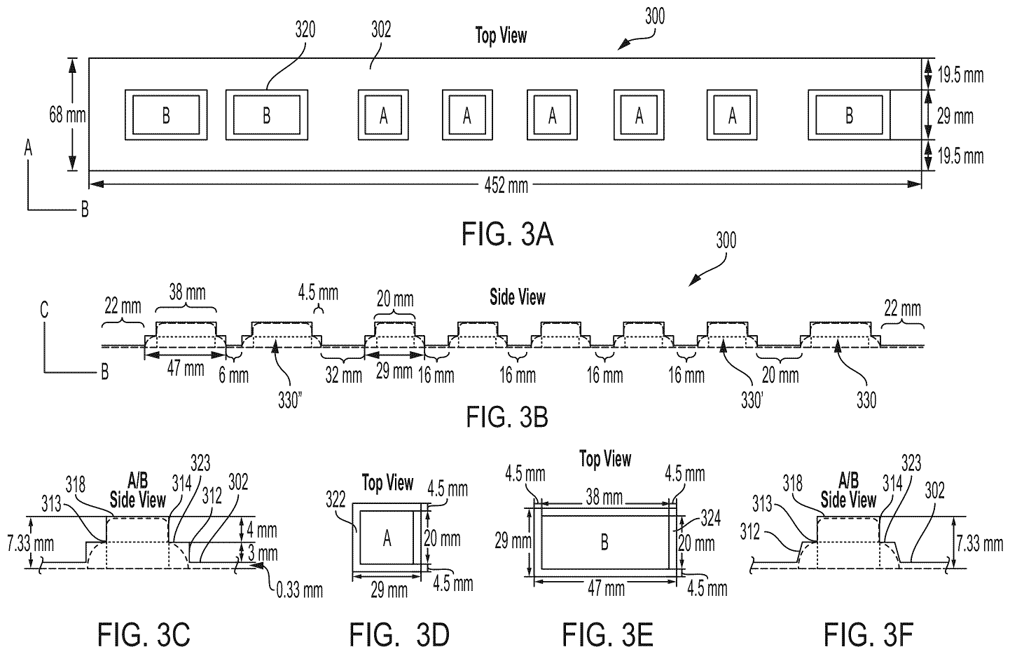

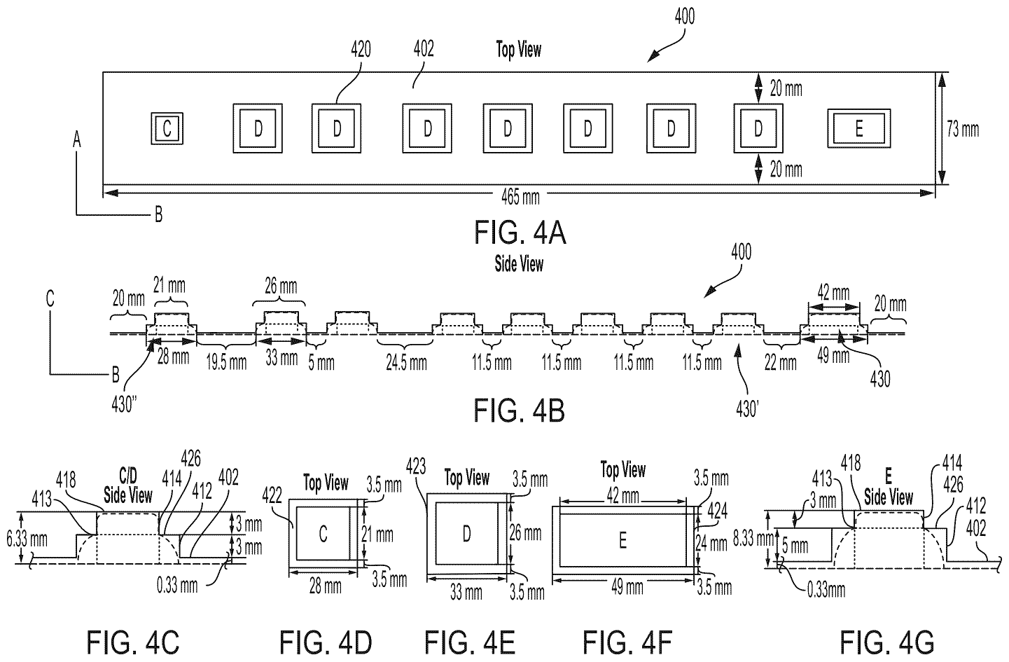

The keyboard cover 200 includes a main keyboard cover surface 210 in a first a-b plane (a-b plane shown in FIG. 4A). The various surfaces described below can be substantially planar or can be substantially conformable to the shape of the underlying keyboard keys to be covered. A plurality of button covers 220 (also referred to as key covers) extends in a second b-c plane (b-c plane shown in FIG. 4B) perpendicular to the first a-b plane. The button covers 220 are aligned on an axis (e.g., b axis) as shown in FIGS. 3-5. The button covers 220 have a stepped shape from a side view, so that a first protrusion 222 (also referred to as first protrusion) has a length and width that is larger than the second protrusion 224 (also referred to as second portion).

As shown, the second protrusion 224 includes a second button frame surface 225 configured to cover a top surface of the key (e.g., button) and the first protrusion 222 includes a first button frame surface 223 configured to cover a top surface of key frame (e.g., button frame) associated with the key. The key frame is a protrusion that surrounds (e.g., covers) the lower side portion of the key. The key surface and the key frame can be planar, as illustrated in FIG. 2.

As shown, the keyboard cover 200 includes a main keyboard cover surface 210 and the plurality of button covers 220 protruded from the main keyboard cover surface 210. The main keyboard cover surface can be planar. As shown, the button covers 220 include a first button cover 220 including a first protrusion 222 and a second protrusion 224. As shown, the first protrusion 222 includes a first button frame surface 223 and the second protrusion 224 includes a second button frame surface 225. As shown, an edge of the first button frame surface 223 non-overlaps with an edge of the second button frame surface 225 in a first direction (e.g., vertical direction). The frame surfaces can also be planar.

As shown, the first protrusion 222 has a first width and second protrusion 224 has a second width. The first width is greater than the second width. The first button frame surface 223 is formed to cover a top surface of a first button frame, and the second button frame surface 225 is formed to cover a top surface of a first button associated with the first button frame. Additionally, the first protrusion 222 and the second protrusion 224 form a first recess that corresponds in shape to a first button and a first button frame associated with the first button. The first protrusion 222 and the second protrusion 224 can form a stepped surface. A width of a bottom portion of the first protrusion 222 and a width of an upper portion of the first protrusion 222 can be the same. In other embodiments (e.g., first protrusion in FIGS. 3F, 4G, 5F), a width of a bottom portion of the first protrusion 222 is greater than a width of an upper portion of the first protrusion 222.

The keyboard cover 200 can include a main keyboard cover surface 210 and a plurality of button covers 220 protruded from the main keyboard cover surface 210. As shown, the button covers 220 include a first button cover 220 and a second button cover adjacent to the first button cover 220. Each of the first button cover 220 and the second button cover can have a first protrusion 222 extended from the main keyboard cover surface 210 and a second protrusion 224 extended from the first protrusion 222. The first protrusion 222 of the first button cover 220 includes a first button frame surface 223 and the second protrusion 224 of the first button cover 220 includes a second button frame surface 225. The first protrusion of the second button cover includes a second button frame surface and the second protrusion of the second button cover includes a second button frame surface. The first button cover 220 and the second button cover are arranged in a first direction.

As shown, a portion of the main keyboard cover surface 210 can be disposed between the first button cover 220 and the second button cover. The first button frame surface 223 is formed to cover a top surface of a first button frame, and the second button frame surface 225 is formed to cover a top surface of a first button. Likewise, the second button frame surface 236 is formed to cover a top surface of a second button frame, and the second button frame surface 225 is formed to cover a top surface of a second button. A first height of the first button frame surface 223 from the main keyboard cover surface 210 and a second height of the second button frame surface 225 from the main keyboard cover surface 210 are the same. In other embodiments, a first height of the first button frame surface 223 from the main keyboard cover surface 210 and a second height of the second button frame surface from the main keyboard cover surface 210 are different.

The first protrusion 222 of the first button cover 220 and the second protrusion 224 of the first button cover 220 form a first stepped surface, and the first protrusion 222 of the second button cover and the second protrusion 224 of the second button cover form a second stepped surface. The first protrusion 222 of the first button cover 220 and the second protrusion 224 of the first button cover 220 form a first recess that corresponds in shape to a first button and a first button frame associated with the first button, and the first protrusion of the second button cover and the second protrusion of the second button cover form a second recess that corresponds in shape to a second button and a second button frame associated with the second button. A width of a bottom portion of the first protrusion and a width of an upper portion of the first protrusion are the same. In other embodiments (e.g., first protrusion in FIGS. 3F, 4G, 5F), a width of a bottom portion of the first protrusion 222 is greater than a width of an upper portion of the first protrusion 222.

FIGS. 3A-3F show top and side views of a keyboard cover 300 (e.g., button panel cover), along with top and side views of key covers 320 (e.g., button covers) in various shapes associated with the keyboard cover 300.

FIG. 3A is a top view of the keyboard cover 300 in accordance with some implementations of the disclosure. A plurality of key covers 320 (e.g., button covers), which form recesses operable to receive keys (e.g., buttons) from the device, are aligned along an axis (e.g., axis B as shown) and extend from a surface 302. The length of the keyboard cover 300 along axis B is greater than the width of the keyboard cover 300 along axis A. Thus, as appreciated, the measurement along the length of axis B is greater than the measurement along the length of axis A. More specifically, the measurement along the axis B can be from 450 mm to 520 mm, more specifically 452 mm. The measurement along the axis A can be from 60 mm to 90 mm, more specifically 68 mm. The key covers 320 extend from the main keyboard cover surface 302 of the keyboard cover 300 and define individual recesses for each key. Although a raised protrusion could be provided on the main keyboard cover surface 302, in most configurations a raised protrusion is not provided to avoid altering the functionality of the cover when the cover is applied and the underlying gaming machine is in use.

Turning to FIG. 3B, the keyboard cover 300 is viewed from a side view along the axis B with the height in the axis C. A plurality of stepped key recesses 330, 330′, 330″ are operable to receive a key into each recess from the device's keyboard interface. Thus, one device key can be positioned within one key recess when the keyboard cover 300 is installed. The size and spacing of each stepped key recess 330, 330′, 330″ corresponds to the size and spacing of the key on the keyboard. Two or more key sizes can be used as illustrated. Each stepped key recess 330, 330′, 330″ has a size as described below. For example, from left to right, the space between key recesses is 6 mm between stepped key recess 1 and stepped key recess 2, 32 mm between stepped key recess 2 and stepped key recess 3, 16 mm between stepped recess 3 and stepped recess 4, stepped recess 4 and stepped recess 5, stepped recess 5 and stepped recess 6, and stepped recess 6 and stepped recess 7, and 20 mm between stepped recess 7 and stepped recess 8.

From a side view of a single key cover 320 is shown in FIG. 3C for “A” key cover 320 and “B” key cover 320. A lower portion of the stepped surface 312 extends from the main keyboard cover surface 302. An upper portion of the stepped surface 314 is recessed from the lower portion of the stepped surface 312 to create a step 313 and extends further away from the main keyboard cover surface 302. The upper portion of the stepped surface 314 has a key surface 318. The lower portion of the stepped surface 312 has a key frame surface 323. The lower portion of the stepped surface 312 extends 3 mm from the main keyboard cover surface 302, and the upper portion of the stepped surface 314 extends 4 mm above from the lower portion of the stepped surface 312, or a total of 7 mm from the main keyboard cover surface 302. Accordingly, the height of the key cover 320 (“A” key cover 320 and “B” key cover 320) is 7.33 mm including the total of 7 mm and the thickness of the surface 302 (0.33 mm). The lower portion of the stepped surface 312 can curve toward the upper portion of the stepped surface 314 and the upper portion of the stepped surface 314 can curve towards the upper surface of the key surface 318. The lower portion of the stepped surface 312 may bend to form a perpendicular as it extends toward the upper portion of the stepped surface 314, and similarly, the upper portion of the stepped surface 314 may bend to form a perpendicular as it extends toward the upper surface of the key surface 318.

As shown, a key cover 320 for a first key size 322 (“A” key cover 320 in FIG. 3D) has a square shape and a length of 29 mm on the lower portion of the stepped surface 312. The upper portion of the stepped surface 314 is also square and has a length of 20 mm. The lower portion of the stepped surface 312 extends 3 mm from the main keyboard cover surface 302, and the top surface of the upper portion of the stepped surface 314 extends 4 mm above the lower portion of the stepped surface 312, or a total of 7 mm from the main keyboard cover surface 302. Accordingly, the height of the key cover 320 (“A” key cover 320) is 7.33 mm including the total of 7 mm and the thickness of the surface 302 (0.33 mm).

As shown, a key cover 320 for a second key size 324 (“B” key cover 320 in FIG. 3E) has a rectangular shape and a length of 47 mm on the lower portion of the first portion of the stepped surface 312 along a first and third side and a length of 29 mm along a second and fourth side. The upper portion of the stepped surface 314 is also rectangular and has a length of 38 mm along a first and third side and 20 mm along a second and fourth side. The lower portion of the stepped surface 312 extends 3 mm from the main keyboard cover surface 302, and the top surface of the upper portion of the stepped surface 314 extends 4 mm above the lower portion of the stepped surface 312, or a total of 7 mm from the main keyboard cover surface 302. Accordingly, the height of the key cover 320 (“B” key cover 320) is 7.33 mm including the total of 7 mm and the thickness of the surface 302 (0.33 mm).

The keyboard cover 300 (e.g., button panel cover) is configurable to cover five square buttons (associated with “A” key cover 320) and three rectangular buttons (associated with “B” key cover 320) along an axis.

From a side view of a single key cover 320 in another embodiment is shown in FIG. 3F. A lower portion of the stepped surface 312 extends from the main keyboard cover surface 302. An upper portion of the stepped surface 314 is recessed from the lower portion of the stepped surface 312 to create a step 313 and extends further away from the main keyboard cover surface 302. The upper portion of the stepped surface 314 has a key surface 318. The lower portion of the stepped surface 312 has a key frame surface 323. Similar to the key cover 320 in FIG. 3C, the height of the key cover 320 in FIG. 3F is 7.33 mm.

The lower portion of the stepped surface 312 can curve toward the upper portion of the stepped surface 314 and the upper portion of the stepped surface 314 can curve towards the upper surface of the key surface 318. The lower portion of the stepped surface 312 may bend at an obtuse angle as it extends toward the upper portion of the stepped surface 314. The upper portion of the stepped surface 314 may bend to form a perpendicular as it extends toward the upper surface of the key surface 318. As shown, the lower portion of the stepped surface 312 can be slanted with respect to the main keyboard cover surface 302. As a result, the lower portion of the stepped surface 312 can be non-perpendicular to surface 302.

FIGS. 4A-4G show top and side views of a keyboard cover 400 (e.g., button panel cover), along with top and side views of key covers 420 (e.g., button covers) in various shapes, in another embodiment of the keyboard cover 400.

FIG. 4A is a top view of a keyboard cover 400 in accordance with some implementations of the disclosure. A plurality of key covers 420, which form recesses operable to receive keys (e.g., buttons) from the device, are aligned along an axis (axis B) and extend from a surface 402. The length of the keyboard cover 400 along axis B is greater than the width of the key cover along axis A. Thus, as appreciated, the measurement along the length of axis B is greater than the measurement along the length of axis A. More specifically, the measurement along the axis B can be from 400 mm to 550 mm, more specifically 465 mm. The measurement along the axis A can be from 60 mm to 90 mm, more specifically 73 mm. The key covers 420 extend from a surface 402 of the keyboard cover 400 and define individual recesses for each key.

Turning to FIG. 4B, the keyboard cover 400 is viewed from a side view along the axis B with the height in the axis C. A plurality of stepped key recesses 430, 430′, 430″ are operable to receive a key into each recess from the device's keyboard interface. Thus, one device key can be positioned within one key recess when the keyboard cover 400 is installed. The size and spacing of each stepped key recess 430, 430′, 430″ corresponds to the size and spacing of the key on the keyboard. Two or more key sizes can be used as illustrated. Each stepped key recess 430, 430′, 430″ has a size as described below. From left to right, the space between key recesses is: 19.5 mm between stepped key recess 1 and stepped key recess 2, 5 mm between stepped key recess 2 and stepped key recess 3, 24.5 mm between stepped recess 3 and stepped recess 4, 11.5 mm between stepped recess 4 and stepped recess 5, stepped recess 5 and stepped recess 6, stepped recess 6 and stepped recess 7, stepped recess 7 and stepped recess 8, and 22 mm between stepped recess 8 and stepped recess 9.

From a side view of a single key cover 420 is shown in FIG. 4C for “C” key cover 420 and “D” key cover 420. A lower portion of the stepped surface 412 extends from the main keyboard cover surface 402. An upper portion of the stepped surface 414 is recessed from the lower portion of the stepped surface 412 to create a step 413 and extends further away from the main keyboard cover surface 402. The upper portion of the stepped surface 414 has a key surface 418. The lower portion of the stepped surface 412 has a key frame surface 426. The lower portion of the stepped surface 412 extends 3 mm from the main keyboard cover surface 402, and the upper portion of the stepped surface 414 extends 3 mm above from the lower portion of the stepped surface 412, or a total of 6 mm from the main keyboard cover surface 402. Accordingly, the height of the key cover 420 (“C” key cover 420 and “D” key cover 420) is 6.33 mm including the total of 6 mm and the thickness of the surface 402 (0.33 mm).

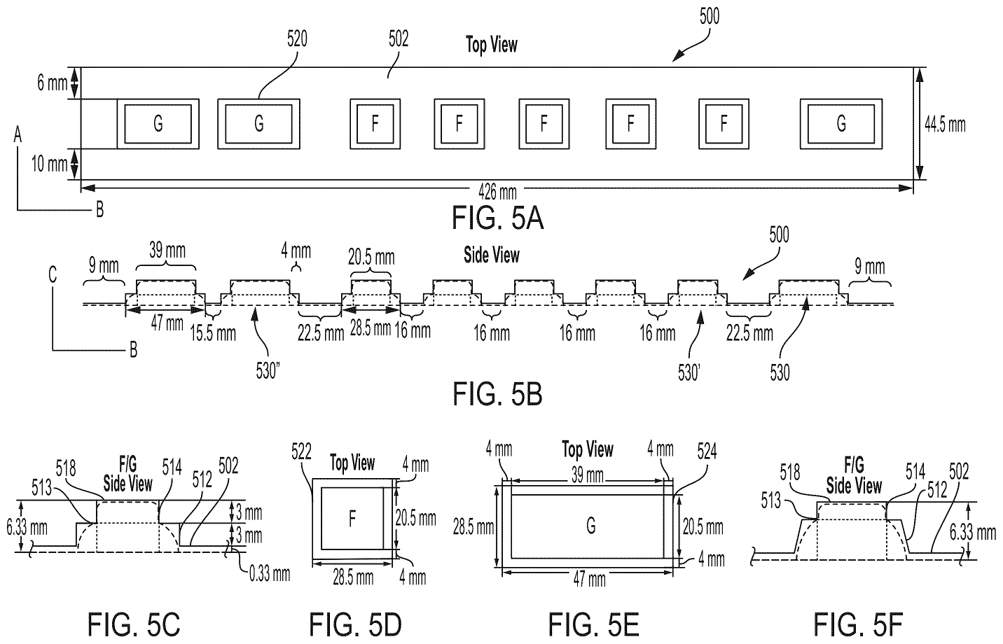

The lower portion of the stepped surface 412 can curve toward the upper portion of the stepped surface 414 and the upper portion of the stepped surface 414 can curve towards the upper surface of the key surface 418. The lower portion of the stepped surface 412 may bend to form a perpendicular as it extends toward the upper portion of the stepped surface 414, and similarly, the upper portion of the stepped surface 414 may bend to form a perpendicular as it extends toward the upper surface of the key surface 418. Similar to FIG. 3F and FIG. 5F, in some implementations, the lower portion of the stepped surface 412 can be slanted with respect to the main keyboard cover surface 402. As a result, the lower portion of the stepped surface 412 can be non-perpendicular to surface 402.

As shown, a key cover 420 for a first key size 422 (“C” key cover 420 in FIG. 4D) has a square shape and a length of 28 mm on the lower portion of the stepped surface 412. The upper portion of the stepped surface 414 is also square and has a length of 21 mm. The lower portion of the stepped surface 412 extends 3 mm from the main keyboard cover surface 402, and the top surface of the upper portion of the stepped surface 414 extends 3 mm above from the lower portion of the stepped surface, or a total of 6 mm from the main keyboard cover surface 402. Accordingly, the height of the “C” key cover 420 is 6.33 mm including the total of 6 mm and the thickness of the surface 402 (0.33 mm).

As shown, a key over 420 for a second key size 423 (“D” key cover 420 in FIG. 4E) has a square shape and a length of 33 mm on the lower portion of the stepped surface 412. The upper portion of the stepped surface 414 is also square and has a length of 26 mm. The lower portion of the stepped surface 412 extends 3 mm from the main keyboard cover surface 402, and the top surface of the upper portion of the stepped surface 414 extends 3 mm above from the lower portion of the stepped surface 412, or a total of 6 mm from the main keyboard cover surface 402. Accordingly, the height of the “D” key cover 420 is 6.33 mm including the total of 6 mm and the thickness of the surface 402 (0.33 mm).

From a side view of a single key cover 420 is shown in FIG. 4G for “E” key cover 420. A lower portion of the stepped surface 412 extends from the main keyboard cover surface 402. An upper portion of the stepped surface 414 is recessed from the lower portion of the stepped surface 412 to create a step 413 and extends further away from the main keyboard cover surface 402. The upper portion of the stepped surface 414 has a key surface 418. The lower portion of the stepped surface 412 has a key frame surface 426. The lower portion of the stepped surface 412 extends 5 mm from the main keyboard cover surface 402, and the upper portion of the stepped surface 414 extends 3 mm above from the lower portion of the stepped surface 412, or a total of 8 mm from the main keyboard cover surface 402. Accordingly, the height of the “E” key cover 420 is 8.33 mm including the total of 8 mm and the thickness of the surface 402 (0.33 mm).

The lower portion of the stepped surface 412 can curve toward the upper portion of the stepped surface 414 and the upper portion of the stepped surface 414 can curve towards the upper surface of the key surface 418. The lower portion of the stepped surface 412 may bend to form a perpendicular as it extends toward the upper portion of the stepped surface 414, and similarly, the upper portion of the stepped surface 414 may bend to form a perpendicular as it extends toward the upper surface of the key surface 418. Similar to FIG. 3F and FIG. 5F, in some implementations, the lower portion of the stepped surface 412 can be slanted with respect to the main keyboard cover surface 402. As a result, the lower portion of the stepped surface 412 can be non-perpendicular to surface 402.

As shown, a key cover 420 for a third key size 424 (key cover 420 in FIG. 4E) has a rectangular shape and a length of 49 mm on the lower portion of the stepped surface 412 along a first and third side and a length of 31 mm along a second and fourth side. The upper portion of the stepped surface 414 is also rectangular and has a length of 42 mm along a first and third side and 24 mm along a second and fourth side. The lower portion of the stepped surface 412 extends 5 mm from the main keyboard cover surface 402, and the top surface of the upper portion of the stepped surface 414 extends 3 mm above from the lower portion of the stepped surface 412, or a total of 8 mm from the main keyboard cover surface 402. Accordingly, the height of the “E” key cover 420 is 8.33 mm including the total of 8 mm and the thickness of the surface 402 (0.33 mm).

The keyboard cover 400 (e.g., button panel cover) is configurable to cover one square button (associated with “C” key cover 420), seven square buttons (associated with “D” key cover 420), and one rectangular button (associated with “E” key cover 420) along an axis.

FIGS. 5A-5F shows a top and side views of a keyboard cover 500 (e.g., button panel cover), along with top and side views of key covers 520 (e.g., button covers) in various shapes, in another embodiment of the keyboard cover 500.

FIG. 5A is a top view of a keyboard cover 500 in accordance with some implementations of the disclosure. A plurality of key covers 520 (e.g., button covers), which form recesses operable to receive keys (e.g., buttons) from the device, are aligned along an axis (e.g., axis B as shown) and extend from a surface 502. The length of the keyboard cover 500 along axis B is greater than the width of the key cover along axis A. Thus, as appreciated, the measurement along the length of axis B is greater than the measurement along the length of axis A. More specifically, the measurement along the axis B can be from 400 mm to 520 mm, more specifically 426 mm. The measurement along the axis A can be from 40 mm to 90 mm, more specifically 44.5 mm. The key covers 520 extend from a surface 502 of the keyboard cover 500 and define individual recesses for each key.

Turning to FIG. 5B, the keyboard cover 500 is viewed from a side view along the axis B with the height in the axis C. A plurality of stepped key recesses 530, 530′, 530″ are operable to receive a key into each recess from the device keyboard. Thus, one device key can be positioned within one key recess when the keyboard cover 500 is installed. The size and spacing of each stepped key recess corresponds to the size and spacing of the key on the keyboard. Two or more key sizes can be used as illustrated. Each stepped key recess 530, 530′, 530″ has a size as described below. From left to right, the space between key recesses is: 15.5 mm between stepped key recess 1 and stepped key recess 2; 22.5 mm between stepped key recess 2 and stepped key recess 3; 16 mm between stepped recess 3 and stepped recess 4, stepped recess 4 and stepped recess 5, stepped recess 5 and stepped recess 6, and stepped recess 6 and stepped recess 7, and 22.5 mm between stepped recess 7 and stepped recess 8.

From a side view of a single key cover 520 is shown in FIG. 5C. A lower portion of the stepped surface 512 extends from the main keyboard cover surface 502. An upper portion of the stepped surface 514 is recessed from the lower portion of the stepped surface 512 to create a step 513 and extends further away from the main keyboard cover surface 502. The upper portion of the stepped surface 514 has a key surface 518. The lower portion of the stepped surface 512 has a key frame surface 526. The lower portion of the stepped surface 512 extends 3 mm from the main keyboard cover surface 502, and the upper portion of the stepped surface 514 extends 3 mm above from the lower portion of the stepped surface 512, or a total of 6 mm from the main keyboard cover surface 502. Accordingly, the height of the key cover 520 is 6.33 mm including the total of 6 mm and the thickness of the surface 502 (0.33 mm).

The lower portion of the stepped surface 512 can curve toward the upper portion of the stepped surface 514 and the upper portion of the stepped surface 514 can curve towards the upper surface of the key surface 518. The lower portion of the stepped surface 512 may bend to form a perpendicular as it extends toward the upper portion of the stepped surface 514, and similarly, the upper portion of the stepped surface 514 may bend to form a perpendicular as it extends toward the upper surface of the key surface 518.

As shown, a key cover 520 for a first key size 522 (“F” key cover 520 in FIG. 5D) has a square shape and a length of 28.5 mm on the lower portion of the stepped surface 512. The upper portion of the stepped surface 514 is also square and has a length of 20.5 mm. The lower portion of the stepped surface 512 extends 3 mm from the main keyboard cover surface 502, and the top surface of the upper portion of the stepped surface 514 extends 3 mm above the lower portion of the stepped surface 512, or a total of 6 mm from the main keyboard cover surface 502. Accordingly, the height of the “F” key cover 520 is 6.33 mm including the total of 6 mm and the thickness of the surface 502 (0.33 mm).

As shown, a key cover for a second key size 524 (“G” key cover 520 in FIG. 5E) has a rectangular shape and a length of 47 mm on the lower portion of the stepped surface 512 along a first and third side and a length of 28.5 mm along a second and fourth side. The upper portion of the stepped surface 514 is also rectangular and has a length of 39 mm along a first and third side and 20.5 mm along a second and fourth side. The lower portion of the stepped surface 512 extends 3 mm from the main keyboard cover surface 502, and the top surface of the upper portion of the stepped surface 514 extends 3 mm above the lower portion of the stepped surface 512, or a total of 6 mm from the main keyboard cover surface 502. Accordingly, the height of the “G” key cover 520 is 6.33 mm including the total of 6 mm and the thickness of the surface 502 (0.33 mm).

The keyboard cover 500 (e.g., button panel cover) is configurable to cover five square buttons (associated with “F” key cover 520) and three rectangular buttons (associated with “G” key cover 520) along an axis.

From a side view of a single key cover 520 in another embodiment is shown in FIG. 5F. A lower portion of the stepped surface 512 extends from the main keyboard cover surface 502. An upper portion of the stepped surface 514 is recessed from the lower portion of the stepped surface 512 to create a step 513 and extends further away from the main keyboard cover surface 502. The upper portion of the stepped surface 514 has a key surface 518. The lower portion of the stepped surface 512 has a key frame surface 526. Similar to the key cover 520 in FIG. 5C, the height of the key cover 520 in FIG. 5F is 6.33 mm.

The lower portion of the stepped surface 512 can curve toward the upper portion of the stepped surface 514 and the upper portion of the stepped surface 514 can curve towards the upper surface of the key surface 518. The lower portion of the stepped surface 512 may bend at an obtuse angle as it extends toward the upper portion of the stepped surface 514. The upper portion of the stepped surface 514 may bend to form a perpendicular as it extends toward the upper surface of the key surface 518. As shown, the lower portion of the stepped surface 512 can be slanted with respect to the main keyboard cover surface 502. As a result, the lower portion of the stepped surface 512 can be non-perpendicular to surface 502.

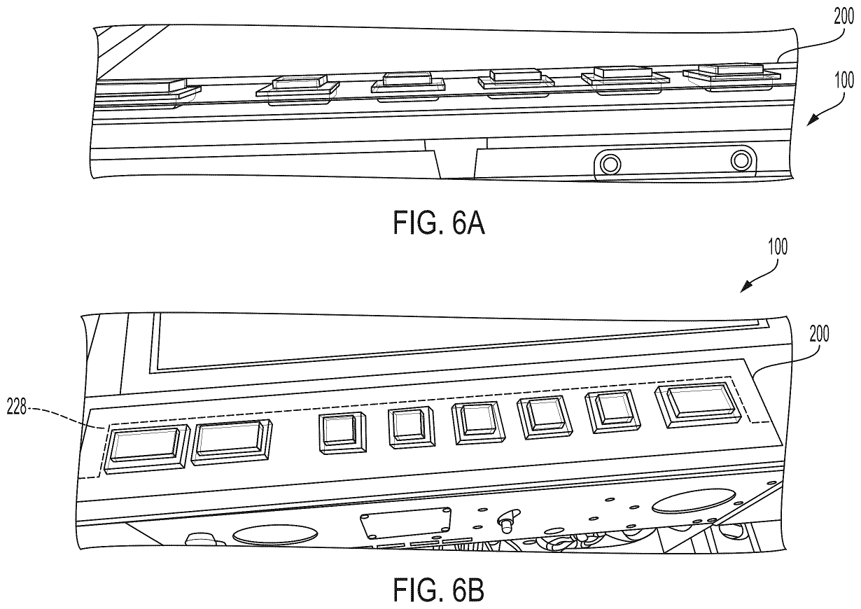

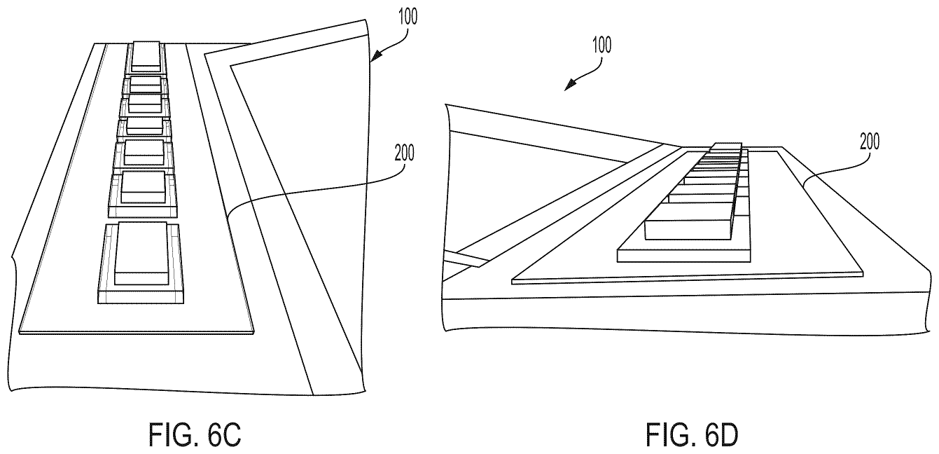

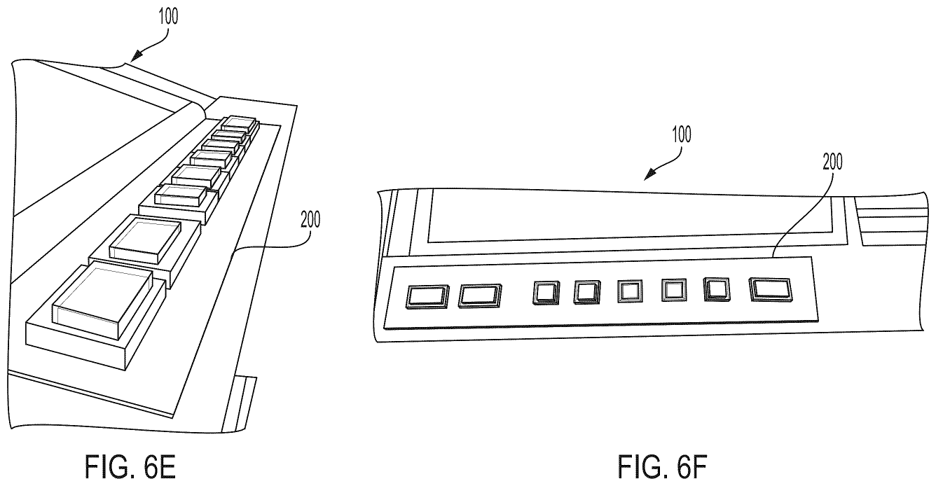

FIGS. 6A-6F illustrate an exemplar keyboard cover applied to an exemplar keyboard interface.

As illustrated from various perspectives, a keyboard cover 200 (such as a button panel cover) is mounted onto the keyboard interface 110 of a device 100 (e.g., a gaming machine). As mentioned earlier, the keyboard cover 200 may feature an adhesive layer (e.g., double-coated acrylic) that allows it to be easily affixed to keyboard interface 110.

### II. Manufacturing Process

The product (e.g., keyboard cover, button panel cover) is made by vacuum-forming a suitable material over a mold of the keyboard interface for a gaming machine. The suitable material can be a flexible plastic sheet formed from a 100% latex free material, TPU, or silicon. The suitable material can include plastic material. The suitable material can include elastomer material (e.g., silicone). For example, the suitable material can include at least one of: silicone rubber, polyvinyl chloride (PVC), thermoplastic elastomer (TPE), polyethylene (PE), polypropylene (PP), polycarbonate (PC), polyethylene terephthalate (PET), or polyurethane (PU). The plastic sheet is heated until the plastic sheet is soft and then the softened plastic sheet is draped it over a mold. A vacuum is applied which brings the plastic sheet in conformed relationship to the mold. Once the plastic cools, the product is removed from the mold and additional surface treatment, such as an adhesive layer or antimicrobial, are applied.

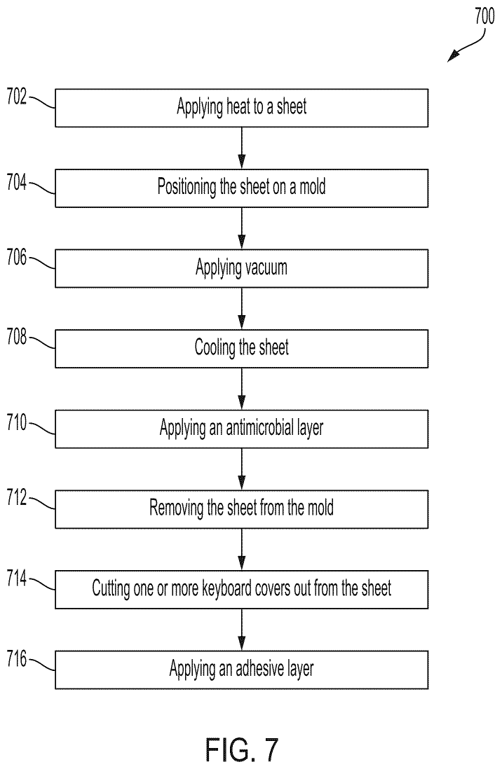

FIG. 7 is a flowchart of an example arrangement of operations for a method 700 of manufacturing a cover (e.g., button panel cover, keyboard cover). The method 700 may be performed by processing logic (controlling an automated molding machine) that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 700, at operations 702, includes applying heat to a sheet (e.g., 100% latex free sheet, TPU sheet, silicon sheet, plastic sheet, elastomer sheet) until the sheet becomes soft (e.g., sheet at a predetermined temperature).

The method 700, at operations 704, includes positioning the sheet on a mold.

The method 700, at operations 706, includes applying vacuum between the sheet and the mold.

The method 700, at operation 708, includes cooling the sheet to a predetermined temperature.

The method 700, at operation 710, includes applying an antimicrobial layer (e.g., antimicrobial treatment) on the top of the sheet.

The method 700, at operations 712, includes removing the sheet from the mold.

The method 700, at operation 714, includes cutting one or more keyboard covers out of the sheet.

The method 700, at operation 716, includes applying an adhesive layer (e.g., double coated acrylic) on the bottom of the sheet.

The mold is wherein the mold is fabricated to produce one or more covers. For example, the one or more covers include a surface, and a plurality of button covers protruded from the main keyboard cover surface. The button covers include a first button cover and a second button cover adjacent to the first button cover. Each of the first button cover and the second button cover has a first protrusion extended from the main keyboard cover surface and a second protrusion extended from the first protrusion. The first protrusion of the first button cover includes a first button frame surface. The second protrusion of the first button cover includes a first primary button surface. The first protrusion of the second button cover includes a second button frame surface, wherein the second protrusion of the second button cover includes a second primary button surface.

While preferred embodiments of the present invention have been shown and described herein, it will be obvious to those skilled in the art that such embodiments are provided by way of example only. Numerous variations, changes, and substitutions will now occur to those skilled in the art without departing from the invention. For example, the use of comprise, or variants such as comprises or comprising, includes a stated integer or group of integers but not the exclusion of any other integer or group of integers. It should be understood that various alternatives to the embodiments of the invention described herein may be employed in practicing the invention. It is intended that any claims presented define the scope of the invention and that methods and structures within the scope of these claims and their equivalents be covered thereby.

What is claimed:

1. A cover comprising:
a main keyboard cover surface; and
a plurality of button covers protruded from the main keyboard cover surface, the button covers including a first button cover, the first button cover including a first protrusion and a second protrusion,
wherein the first protrusion includes a button frame surface, the second protrusion includes a primary button surface, and an edge of the button frame surface non-overlaps with an edge of the primary button surface in a first direction.

2. The cover of claim 1, wherein the first protrusion has a first width and second protrusion has a second width less than the first width.

3. The cover of claim 1, wherein the button frame surface is formed to cover a top surface of a first button frame, and the primary button surface is formed to cover a top surface of a first button associated with the first button frame.

4. The cover of claim 1, wherein the first protrusion and the second protrusion form a first recess that corresponds in shape to a first button and a first button frame associated with the first button.

5. The cover of claim 1, wherein the main keyboard cover surface includes a semi-clear thermoplastic polyurethane layer.

6. The cover of claim 1, wherein the first protrusion and the second protrusion form a stepped surface.

7. The cover of claim 1, wherein a width of a bottom portion of the first protrusion is greater than a width of an upper portion of the first protrusion, and the upper portion of the first protrusion is closer to the second protrusion than the bottom portion of the first protrusion.

8. The cover of claim 1, further comprising an adhesive layer.

9. The cover of claim 1, further comprising an antimicrobial layer.

10. The cover of claim 1, wherein the first direction is a vertical direction.

11. A cover, comprising:
a main keyboard cover surface; and
a plurality of button covers protruded from the main keyboard cover surface, the button covers including a first button cover and a second button cover adjacent to the first button cover,
wherein each of the first button cover and the second button cover has a first protrusion extended from the main keyboard cover surface and a second protrusion extended from the first protrusion, the first protrusion of the first button cover includes a first button frame surface, the second protrusion of the first button cover includes a first primary button surface, the first protrusion of the second button cover includes a second button frame surface, and the second protrusion of the second button cover includes a second primary button surface.

12. The cover of claim 11, wherein the first button cover and the second button cover are arranged in a first direction.

13. The cover of claim 11, wherein a portion of the main keyboard cover surface is disposed between the first button cover and the second button cover.

14. The cover of claim 11, wherein the first button frame surface is formed to cover a top surface of a first button frame, the first primary button surface is formed to cover a top surface of a first button, the second button frame surface is formed to cover a top surface of a second button frame, and the second primary button surface is formed to cover a top surface of a second button.

15. The cover of claim 11, wherein a first height of the first button frame surface from the main keyboard cover surface and a second height of the second button frame surface from the main keyboard cover surface are the same.

16. The cover of claim 11, wherein a first height of the first button frame surface from the main keyboard cover surface and a second height of the second button frame surface from the main keyboard cover surface are different.

17. The cover of claim 11, wherein the first protrusion of the first button cover and the second protrusion of the first button cover form a first stepped surface, and the first protrusion of the second button cover and the second protrusion of the second button cover form a second stepped surface.

18. The cover of claim 11, wherein the first protrusion of the first button cover and the second protrusion of the first button cover form a first recess that corresponds in shape to a first button and a first button frame associated with the first button, and the first protrusion of the second button cover and the second protrusion of the second button cover form a second recess that corresponds in shape to a second button and a second button frame associated with the second button.

19. The cover of claim 11, wherein a width of a bottom portion of the first protrusion is greater than a width of an upper portion of the first protrusion, and the upper portion of the first protrusion is closer to the second protrusion than the bottom portion of the first protrusion.

20. A method of manufacturing a cover, comprising:
applying heat to a sheet;
positioning the sheet on a mold; and
applying vacuum between the sheet and the mold,
wherein the mold is fabricated to produce one or more covers, and the one or more covers include
a main keyboard cover surface, and
a plurality of button covers protruded from the main keyboard cover surface, the button covers including a first button cover and a second button cover adjacent to the first button cover,
further wherein each of the first button cover and the second button cover has a first protrusion extended from the main keyboard cover surface and a second protrusion extended from the first protrusion, the first protrusion of the first button cover includes a first button frame surface, the second protrusion of the first button cover includes a first primary button surface, the first protrusion of the second button cover includes a second button frame surface, and the second protrusion of the second button cover includes a second primary button surface.
